(19) United States
(12) Patent Application Publication
(10) Pub. No.: US 2011/0185673 A1
(43) Pub. Date: Aug. 4, 2011

(54) PRECISION GROUND CONCRETE MASONRY BLOCKS AND SYSTEM AND METHOD FOR THE HIGH-SPEED APPLICATION OF MORTAR/GROUT TO PRECISION GROUND CONCRETE MASONRY BLOCKS AND SELF-LEVELING INSTALLATION OF CONCRETE MASONRY SYSTEMS

(75) Inventor: Alan C. Ferguson, Dacula, GA (US)

(73) Assignee: FSN, LLC, Manchester, NH (US)

(21) Appl. No.: 12/848,438

(22) Filed: Aug. 2, 2010

Related U.S. Application Data
(63) Continuation of application No. 12/466,972, filed on May 15, 2009.
(60) Provisional application No. 61/230,358, filed on Jul. 31, 2009.
(60) Provisional application No. 61/249,619, filed on Oct. 8, 2009.
(60) Provisional application No. 61/258,352, filed on Nov. 5, 2009.
(60) Provisional application No. 61/319,999, filed on Apr. 1, 2010.

(51) Int. Cl. E04B 2/02; E04B 2/72; E04C 1/00; B28B 11/08

(52) U.S. Cl. 52/604; 52/745.09; 52/745.1; 264/162

(57) ABSTRACT

A stackable building block for constructing a masonry wall includes a front section having an outer surface, an inner surface, a bottom surface, and a top surface. The top surface includes one or more regions having a higher surface height that is manufactured and then precision ground to the desired height and positioned between or next to lower surface areas. The building block also has a rear section substantially parallel to the front section and similarly arranged. The top surface may include a tapered region beginning proximate at least one of the side or end regions and tapering outwardly away from the side toward the center of the block. The tapered region may include an indentation. The tapered region and indentation provide a true mortar joint capability and resistance to water infiltrating the joint. During assembly of the stack building block, a thin set mortar, grout or adhesive is used between successive courses and that is applied using a high speed applicator.

### CROSS-REFERENCE TO RELATED APPLICATIONS

This application is a continuation of U.S. patent application Ser. No. 12/466,972 filed on May 15, 2009 entitled “SYSTEM AND METHOD FOR PRECISION GRINDING AND SELF-LEVELING INSTALLATION OF CONCRETE MASONRY SYSTEMS”. The present application also claims priority to: U.S. Provisional Patent Application 61/230,358 filed on Jul. 31, 2009 entitled “SYSTEM AND METHOD FOR PRECISION GRINDING AND SELF-LEVELING INSTALLATION OF CONCRETE MASONRY SYSTEMS”; U.S. Provisional Patent Application 61/249,619 filed on Oct. 8, 2009 entitled “SYSTEM AND METHOD FOR PRECISION GRINDING AND SELF-LEVELING INSTALLATION OF CONCRETE MASONRY SYSTEMS”; U.S. Provisional Patent Application 61/258,352 filed on Nov. 5, 2009 entitled “SYSTEM AND METHOD FOR PRECISION GRINDING AND SELF-LEVELING INSTALLATION OF CONCRETE MASONRY SYSTEMS”; and U.S. Provisional Patent Application 61/319,999 filed on Apr. 1, 2010 entitled “SYSTEM AND METHOD FOR THE HIGH-SPEED APPLICATION OF GROUT TO PRECISION GROUND CONCRETE MASONRY AND SELF-LEVELING INSTALLATION OF CONCRETE MASONRY SYSTEMS”; all of which are incorporated fully herein by reference.

### TECHNICAL FIELD

The present invention relates to stack concrete masonry systems for building structural load bearing and non-load bearing walls and, more particularly, to a system and method that utilizes precision grinding of pads on a top portion of masonry blocks in addition to a mechanical system and method for high-speed, precision application of a masonry adhesive or mortar/grout. The ground leveling pads “self-level” the masonry blocks to provide for accurate and simplified assembly of concrete masonry while the applied mortar/adhesive serves to both adhere the blocks together and serves as a high speed, building code approved mortar/grout between horizontal and vertical surfaces of adjacent blocks.

### BACKGROUND INFORMATION

Present masonry construction techniques provide for essentially two masonry construction techniques: the traditional mortared block technique where mortar is placed between each block both on a horizontal face as well as a vertical face; and a newer technique of dry stacking where blocks are designed to be simply placed one upon the other in some arrangement without any mortar between the blocks themselves. An advantage of dry stack masonry systems is that the labor component of installation can be dramatically reduced. Some studies have shown that dry stack masonry systems are up to ten times faster to install than conventional joint mortared masonry systems and require a significantly less skilled labor force to install them. Because these systems do not use bonding mortar to provide joint support, it may be necessary to use other means of developing wall strength to meet various building codes which limits its usefulness.

For example, various building codes may require dry-stacked concrete block cells to be fully filled withconcrete grout in order to provide specified structural integrity. Some applications may require all the cells to be filled with concrete. Other applications may require the concrete to be poured into distinct vertical columns and only in certain cells or cores of the block. These applications may require cells, for example, to be filled generally at four foot on center increments and/or at wall corners and jambs of windows and doors or various load points. A general overview of the use of current dry stack methods in masonry wall construction can be found in National Concrete Masonry Association's (NCMA) technical publication TEK 14-22 “Design and Construction of Dry-Stack Masonry Walls” Incorporated herein by reference.

Currently, the accepted practice for constructing with concrete masonry units using the traditional mortared technique (structural concrete block) requires that the blocks be mortared together with a code approved masonry mortar mix. Typical masonry mortar mixes contain portland cement, lime and mason sand, as well as additives for improving workability. These masonry mortar mixes are applied and installed by an experienced mason using a trowel. The trowel has been used in constructing masonry walls for centuries, without much of any change in design. As a result, the availability of a skilled mason applying mortar with a trowel becomes the limiting factor in the how fast a masonry wall can be constructed. Masonry up to now had been very skilled and labor intensive. The amount of labor cost to install a masonry wall is currently in the range of 66% to 75% of the overall masonry construction costs.

There have been attempts to change the dynamics of the masonry construction market in an attempt to lower the labor expenses associated with typical block concrete construction. As a result, many systems have attempted to eliminate the need for mortar during construction of the wall. The dry-stack masonry wall describe above is one such example. By eliminating the mortar step, the installer should be able to go much faster in erecting walls. The issue with current mortar-less systems, however, is that these systems do not have sufficient height control to duplicate the height control capability of a mortar joint between block that can be adjusted to take care of standard concrete masonry units block height irregularities. The mortar, besides providing bonding and sealing, also serves as a leveling mix that provides a way for the wall builder to adjust the height and level of the courses to meet the specific dimensions for openings and top of wall elevations. Moreover, dry stack masonry walls may not have the same load/shear strength as traditional mortared masonry walls and many building codes recognize this and are reluctant to change to allow dry-stack masonry walls in many applications. Drystacked concrete masonry walls generally must be reinforced and/or grouted. Over half the market for masonry is “un-reinforced”.

Given that construction codes and the previous personal experiences of contractors, building inspectors and masons generally encourages or requires mortared concrete walls, a system that includes a thin mortar and grout along with a system and method to apply such thin joint mortar developed to meet or exceed the requirements of the Masonry Standard for Unit Mortared Masonry ASTM-C270 Type S/M) for use with precision ground masonry blocks is required. Mortar application techniques should be designed to eliminate the need to use a mason's hand trowel to apply mortar to masonry blocks. All non-trowel, conventional ways of applying mortar using (1) a standard grout bag (baker's bag) for small project applications and (2) a high speed mortar pump system for large project commercial-style applications are too slow or too messy or both. Traditional mortared masonry has been installed with the aid of a mason's hand trowel. Much skill and effort is required to effectively apply mortar to masonry structures with a trowel. The disclosed precision ground masonry block along with the disclosed easy flow mortar eliminates the need for skilled masons and reduces mortar volume on a project by up to 90%, making it highly effective and efficient. But such easy flow Flow mortar must be applied using a fast and effective way to make it outperform traditional trowel applied installations. Using just a grout bag is too slow while using a mortar pumping device with simple nozzles can be too messy and requires significant level of skill.

Accordingly, a need has existed for a system and method that provides a self-leveling masonry block (the block does not rely of the mortar to level or control the height of the block) having one or more predetermined areas (that are smaller than full top surface area of the masonry block) that can be ground down to a precise level to ensure that there will be no “rocking” or un-levelness in the stacked blocks and that are installed using a non-hand trowel applied mortar/grout or adhesive which serves to adhere the blocks together without the need to use skilled masons using hand trowels and large amounts of conventional mortar (much of which is wasted or classified as “trash” Also needed are special tools and methods that may be attached to traditional grout bags and/or mortar pumping systems such that the mortar may be applied between the masonry blocks or on the face of the blocks (as grout between the blocks, or both) that is fast, easy to use, clean and effective and that requires little or no skill to use and apply.

### SUMMARY

In order to solve the problems associated with conventional mortared masonry and with the mortar less/dry-stacked methods of building masonry walls, a new system was developed. This novel system combines a wet-stacking installation method (applying mortar/grout between the blocks as they are being installed—versus dry stacking which is simply stacking the concrete blocks with no mortar/adhesive or grout between the blocks as they are being installed) with self-leveling and precision ground concrete building blocks. This system eliminates the need for hand trowel-applied mortar. The system dramatically reduces the need for highly skilled masons in the overall construction crew, while also providing nearly the speed of conventional dry-stack methods and systems.

In one aspect the invention features a method of producing a stackable building block for constructing a masonry wall. The method comprises the acts of molding a concrete block having a front section coupled to and substantially parallel with a rear section. Each front and rear sections has a bottom surface and a top surface, wherein the top surface on both the front and rear sections includes at least a central region having a height which is greater than the first and second end regions located on either side of the central region. The method also includes grinding the central region of the top surface of the front and rear block sections to a predetermined height.

The method of producing a stackable building block for constructing a masonry wall utilizes a building block that is a dry stackable concrete block. Alternatively, the method of producing a stackable building block with mortar/grout/adhesive for constructing a masonry wall utilizes a building block that is a wet stackable concrete block.

In another aspect of the invention, the method of producing a stackable building block for constructing a masonry wall includes at least a front surface having a sloping edge region for accepting mortar/adhesive and forming an area into which mortar/adhesive can flow and be worked to for a traditional looking mortared joint.

In a further embodiment of the invention, the method of producing a stacked building block wall utilizing the stackable building block further comprises applying a flowable, thin set mortar onto the top surface of the stackable building block using a high-speed applicator. The high-speed application may be a grout bag or grout pump. The mortar is applied to a minimum thickness of typically ⅛ of an inch or less.

In another embodiment of the invention, the grinding of the higher surface of the top surface is precision ground to provide a stack building block of a specific precision height (typically 8″ in the USA)

In an additional embodiment of the invention, the central region of the top surface further may include a plurality of indents or serrations or channels. The method of producing a stacked building block wall utilizing the stackable building block further comprises the acts of applying a bead/slug of a special flowable, thin set mortar/grout/adhesive onto the top surface of the stackable building block using a high speed applicator and allowing the mortar/grout/adhesive to enter the plurality of indents or serrations or channels on the central region of the top surface, wherein the addition of the mortar does not significantly increase the specific precision height of the stackable building block as installed. Next, the method comprises stacking a second duplicate stack block staged halfway off-center from the first block and stacking a third duplicate stack block staged halfway off-center in a direction opposite and adjacent to the second stack block.

In a further aspect of the invention, the stack building block has a chamfered or beveled edge on one more exterior edges of the building block.

It is important to note that the present invention is not intended to be limited to a system or method which must satisfy one or more of any stated objects or features of the invention. It is also important to note that the present invention is not limited to the preferred, exemplary, or primary embodiment(s) described herein. Modifications and substitutions by one of ordinary skill in the art are considered to be within the scope of the present invention which is not to be limited except by the allowed claims and their legal equivalents.

### BRIEF DESCRIPTION OF THE DRAWINGS

These and other features and advantages of the present invention will be better understood by reading the following detailed description, taken together with the drawings wherein:

FIG. 1A is a side profile view and FIG. 1B is a top plane view of the stretcher unit according to an exemplary edge-grinding embodiment of the present invention;

FIG. 2A is a side profile view and FIG. 2B is a top plane view of the stretcher unit according to a second exemplary edge-grinding embodiment of the invention;

FIG. 3A is a front profile view and FIG. 3B is a top plane view of the corner unit according to an exemplary edge-grinding embodiment of the invention;

FIGS. 4A and 4B are right and left perspective views respectively of a stretcher block unit showing a raised pad area at the interior or central location and faux mud joints at the end/sides of the block;

FIGS. 5A and 5B are a front and side cross-sectional detailed view of a block according to the present invention;

FIGS. 6A and 6B are a sectional side view and a sectional top view respectively showing the machine made full mud joints feature of the present invention;

FIG. 7 is a corner top view detail showing the corner treatment on blocks according to the present invention;

FIGS. 8A, 8B and 8C are partial top views illustrating the position of a bead of mortar with regards to the front, middle and back top surface of the block;

FIG. 9A illustrates the embodiment of the present invention wherein the top edge of the block has a generally linear taper from approximately ⅛ inch to ⅜ of an inch to form a conventional looking and behaving ⅜ inch joint that can be tooled with conventional masonry tools and that includes an optional indentation to help stop water infiltration and increase mechanical gripping between the mortar/block/adhesive and the block.

FIG. 9B illustrates an embodiment of the present invention wherein the top edge of the block has an arcuate taper from approximately ⅛ inch to ⅜ of an inch to form a conventional looking and behaving ⅜ inch bed joint that can be tooled with conventional masonry tools, while vertical (head) joints are handled in a similar manner;

FIG. 10 is a schematic drawing of a grout bag tool that injects the easy flow mortar/grout/adhesive in accordance with yet another feature of the present invention;

FIG. 11 is a schematic drawing of a grout bag applicator/injector tool according to the present invention;

FIG. 12 is a schematic drawing of grout being dispensed from the grout bag tool of the invention;

FIG. 13 is a schematic diagram of the grout bag tool of the invention applying/injecting grout to the front of a concrete block wall and tooling the joint at the same time;

FIG. 14 is a schematic diagram illustrating a mortar pump tool for applying mortar/adhesive in accordance with yet another feature of the present invention;

FIG. 15 is a schematic diagram of the tapered tip used in connection with the mortar pump tool of the invention;

FIG. 16 is a schematic diagram showing twin tips on the mortar pump tool of the invention;

FIG. 17 is a schematic drawing showing twin beads/slugs of mortar/adhesive as applied simultaneously to the front and rear bed joints of a course of concrete blocks using the mortar pump tool of the invention; and

FIG. 18 is a schematic drawing showing twin beads of mortar/adhesive as applied simultaneously to one head joint of a concrete block using the mortar pump tool of the invention.

### DETAILED DESCRIPTION

The present invention features a masonry block system and method providing masonry blocks having top surface regions that self-level the blocks without the use of mortar or adhesive and to an adhesive/grout/mortar formulation and application system that allows for a generally non-skilled work to quickly apply a limited amount of adhesive to a masonry block and to, in one embodiment, simultaneously grout the masonry joint, as will be explained in further detail below. As used herein, the terms grout or adhesive or mortar are used interchangeably.

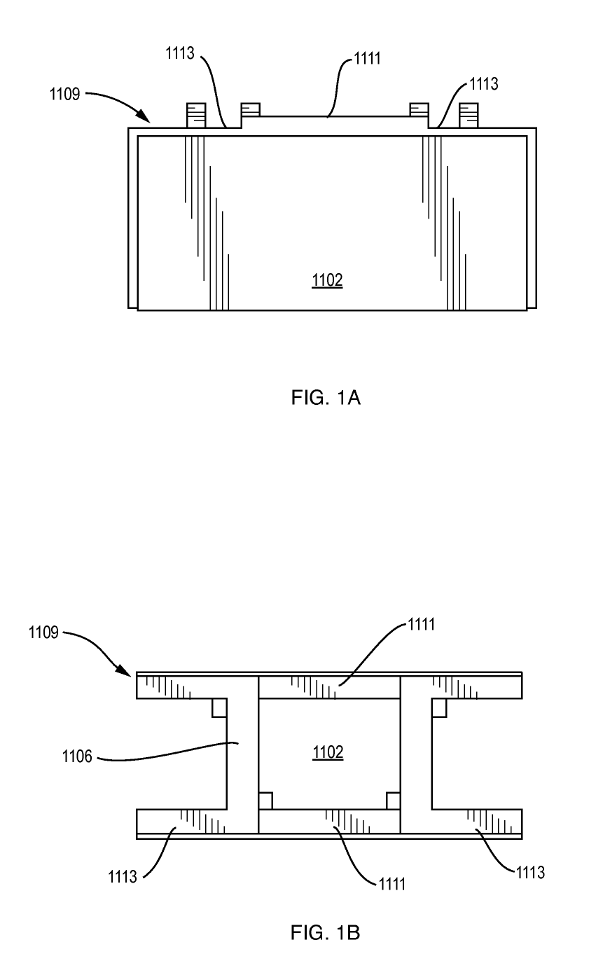

Referring to FIGS. 1A and 1B, multiple levels are provided on the top surface 1109 of a “stretcher” masonry block unit 1102. Although this feature of the invention will be explained on and in connection with a dry-stack block having a certain configuration and additional features that facilitate and enhance dry stacking, this is not a limitation of this feature of the invention as the stepped top surface profile and use of mortar/grout or adhesive described herein can be performed with any type of block have essentially any configuration and additional features, including but not limited to, a traditional mortared block.

According to an exemplary embodiment of the invention, the top surface 1109 may be divided into regions of varying levels during the molding process. The stretcher unit 1102 may be molded with a central region 1111 having a slightly higher or raised surface 1500/1502 than the adjacent top surfaces 1113 which have a lower profile by approximately ⅛ inch. Additional regions of the block such as end regions and the like may also include and benefit from such raised surfaces that are also ultimately ground to a precision height. After the molding process, the top of the raised surface 1500/1502 which may be in the range of approximately 2″ to 7″ in length (and preferably only about 3″ in length) are ground to provide a more accurate, precision height of the stretcher unit 1102.

The lower surface areas 1113 are molded at a height slightly below the ultimate desired height of the stretcher unit 1102, while the higher surface region 1500/1502 in the central part 1111 of the block front and rear sections are molded slightly higher than the desired height of the stretcher unit 1102. Since masonry blocks are typically made from a mixture of concrete, sand and small stones, the ultimate height and “levelness” of each block can and does vary, particularly because of the effects of the small stones which may protrude upwards from the concrete block. In the prior art, this variation in height was taken care of by the application of a fairly thick layer of mortar, applied by a skilled mason using a hand trowel, all of which is eliminated by the present invention.

During the grinding process, these height irregularities are eliminated. The grinder will either not or perhaps barely grind the lower surface 1113 due to the height being just shy of the set grinding height. As the higher surface pads 1502/1500 passes under the grinder, the grinder removes a portion of the concrete block unit material that exceeds the desired height providing a more accurate stretcher unit 1102 height in view of the molded height. By reducing the amount (length) of the stretcher unit 1102 to be ground down (i.e. a rather short 3″ or so central region 1111 and any potential raised height end regions), there is improved grinding performance resulting from an increase in the throughput speed as well as reduced wear on the grinding heads.

For example, when manufacturing an eight-inch high unit, the block may be molded with lower surface 1113 being a one-sixteenth ( 1/16) of an inch shy of eight inches and the higher surface(s) 1500/1502 being a one-sixteenth ( 1/16) of an inch above eight inches. During the grinding process, the grinder may remove portions of the higher surface 1500/1502 providing a height that is eight (8) inches to a greater degree of 1/64″ or less of an inch accuracy. This accuracy allows for good overall height control of the wall and levelness (since blocks in the next row above will touch two (2) or more raised and ground regions 1500/1502 on two (2) blocks in the row or course underneath the present block) without the block “rocking” which is normally not a problem in a mortared wall since the mortar takes up any unevenness in the blocks.

The precision ground block units provide for precision height control even when mortared together. The design provides for lower surfaces 1113 and a higher surface 1500/1502, which reduces the amount of influence the mortar has on adding height to the courses of the wall. The higher surface 1500/1502 may further have an appropriate number of indentations (grooves or channels) that serve to reduce the mortar influence in height control to almost zero by providing channels or grooves into which any adhesive, grout or thin mortar placed on the higher surface may flow. Any grout, adhesive or this mortar in the grooves or indentations will still serve to adhere the top surface of this block with the bottom region of a block placed on top of the block. This higher surface 1500/1502 is then ground to the desired height to provide units of precision height. The geometry of the higher 1500/1502 and lower 1109 surfaces and the indents in the top surface 1109 are designed in such a way as to provide a self-leveling aspect to the wall construction. The self-leveling feature allows for high stacking productivity even if the field conditions are not perfect. The self-leveling provides for a near foolproof solution that allows the construction of the concrete block wall to be more forgiving.

As an example, if foreign materials are present in one level of the stacking, as subsequent courses are stacked, there is little or no potential for “rocking” of a block. The precision ground region of the higher surface 1500/1502 located in the top surface 1111 of the block's face will implement the self-leveling feature and allow for an instant remedy to blocks that would otherwise by crooked or at an angle. The problem of angled or crooked blocks can be remedied immediately without the need for shims or grinding.

The surface-grinding embodiment described above is not limited to the lower surface 1109 being lower than the desired height. The lower surface 1109 may be molded to the exact height of the desired stretcher unit 1102. In this example, additional grinding may be required with the bulk of the grinding occurring on the higher surface 1500/1502. Additionally, the surface-grinding embodiment may have different lengths of higher surfaces 1500/1502 and lower surfaces 1109. In one embodiment, each surface is roughly divided into thirds; however, the invention if not limited to this exemplary width and ratio. The higher surface 1500/1502 may be greater or less than a third of the overall length of the cement block. In addition to grinding certain predetermined regions of the front and rear top portion of the blocks, certain end portion, such as end portion 1315 may also be ground to assist in providing a wall construction of uniform height.

After manufacturing and precision grinding of the stretcher units 1102, the stretcher units 1102 may be assembled as previously discussed herein. In the preferred embodiment of the method of the present invention, an adhesive (also termed grout or thin mortar) is applied between each course of the stretcher units 1102. The adhesive may be squeezed out from the areas between the higher surface 1500/1502 and the bottom of the next course of units. Preferably, the adhesive may be applied on the top surface 1109 of the stretcher unit 1102 that does not have any raised area 1500/1502. In this manner, the adhesive has no impact on the height of the block wall. The height is controlled solely by the precision ground areas. The adhesive preferably remains in areas between the lower surface 1109 and the bottom of the next course of stretcher block units 1102 placed on top of the current block. Once the adhesive cures, the adhesive may provide additional load bearing support that typically meets or exceeds code specifications. The adhesive may be an expandable adhesive to aid in the filling of voids between surfaces. The adhesive in this case is selected to provide a desired expansion force that prevents movement of the stretcher unit 1102 after proper positioning while expanding to fill any voids or spaces between surfaces of blocks 1102 stacked one on top of the other.

An exemplary code compliant mortar/grout/adhesive according to one feature of the present invention was designed and developed to be applied without a trowel but rather, using a high-speed applicator as will be explained further below. Examples of such a high-speed applicator include a grout bag or a grout pump well known in the industry for applying grout to tiles/brick (tuckpointing) or to the exterior face of previously erected block walls. The stackable block design of the present invention allows for the mortar/adhesive disclosed herein to be easily squeezed between the subsequent blocks to a thickness of typically less than ⅛ of an inch so that the mortar is not dictating the height of the wall. Rather, the height of the wall is dictated by the high-speed grinding height gauging process that each block passes through to make it a precision height unit with tolerances that are an order of magnitude better than in the ASTM C-90 block standard (less than 1/64″ compared to the +/−⅛″ standard). Fine grained thin set mortar readily available in general home building supply stores like that used for laying tile on floors or walls will work well with the present invention as the mortar/adhesive.

A mortar/adhesive may also be provided that has properties that conform to the Masonry Standard for Unit Mortared Masonry (in the USA—ASTM C-270) but is also designed so that it can be applied at high speeds without a trowel or experienced applicator and applied so that it does not interfere with the height control aspects of the precision block of the invention. Such a code approved mortar can be applied at a thickness as thin as 1/64 of an inch. The mortar is ultra fine grained and made with cements, aggregates and chemical modifiers as in the thin set motors described above that give it its unique properties. The particles in the mortar are typically less than 5/1000 of an inch. The mortar should have good water retention and should not dry out through evaporation or through suction from the dry block to which it is applied. The water retention of the mortar allows the mortar to remain flowable after application to the block allowing all unnecessary mortar to flow or squeeze out from between two blocks. If the mortar where to lose its ability to flow, the mortar would add too much thickness between the blocks and would affect the ability of the wall to be built to meet specified elevations.

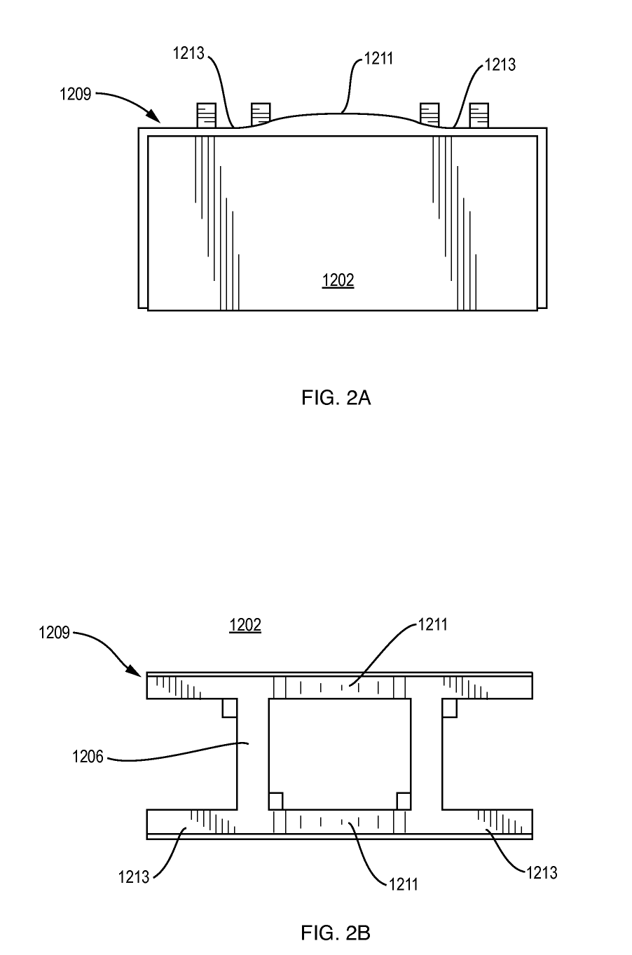

Multiple levels may be provided on the top surface 1109 of a stretcher unit 1102. According to a second exemplary edge-grinding embodiment, the top surface 1109 may be divided into regions of varying levels during the molding process. The stretcher unit 1202 may be molded with a curved top surface 1209 that has a higher surface 1211 sloping down to the adjacent top lower surfaces 1213. After the molding process the top surface 1202 may be ground to provide a more accurate height of the stretcher unit 1202 as previously described with regard to the embodiments in FIGS. 1A and 1B. Other embodiments of previously described in FIGS. 1A and 1B may also be incorporated in the embodiments of FIGS. 2A and 2B.

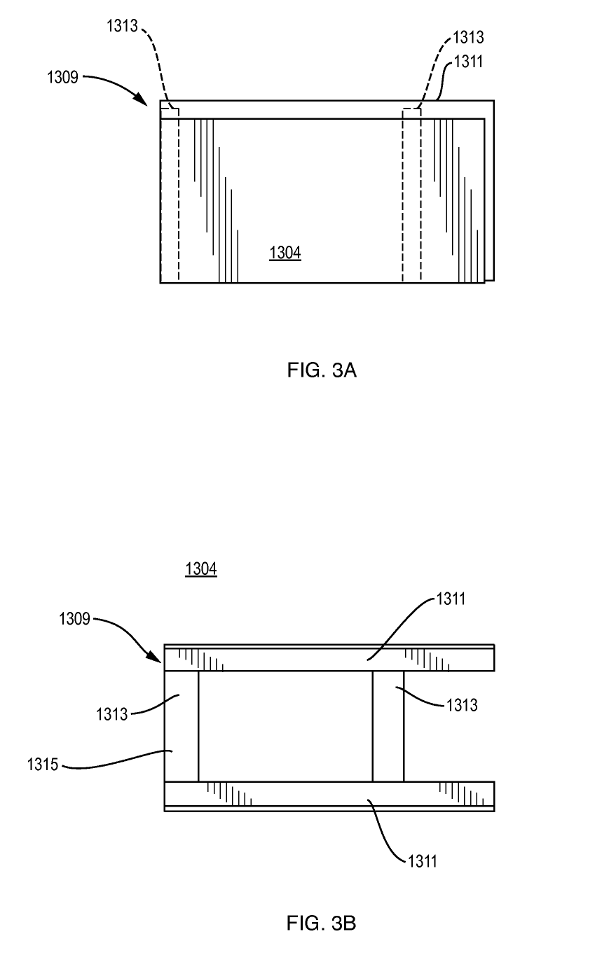

Referring to FIGS. 3A and 3B, multiple levels may be provided on the top surface 1309 of a corner unit 1304. According to an exemplary surface-grinding embodiment, the top surface 1309 may be divided into regions of varying levels during the molding process. The corner unit 1304 may be molded with a top surface 1309 that has a higher surface 1311 slightly higher than adjacent top lower surfaces 1213. After the molding process, the top surface 1311 may be ground to provide a more accurate height of the corner unit 1304 as previously described with regard to embodiments in FIGS. 1A and 1B. Other embodiments of previously described in FIGS. 1A and 1B may also be incorporated in the embodiments of FIGS. 3A and 3B.

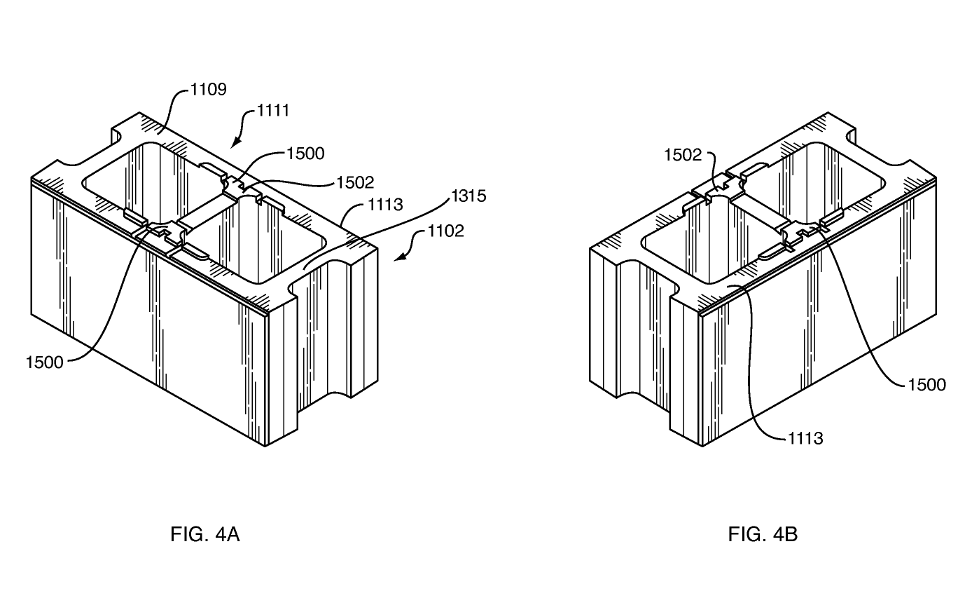

The present invention features a block and method which allows for fine height control and adjustment by quickly and easily changing the location where the installer positions a bead of mortar on the bed joint of the block. The combination of the location or placement of raised pads 1500, FIG. 4 which are formed during the block making process and subsequent precision grinding of the raised pads, along with the application of a thin bead of mortar/adhesive to the top face of a block allows for a thinner mortar bed and very thin bed joints (the joint between a lower block and an upper block) of less than ⅛ of an inch per block as well as stronger joints and walls (thinner joints have been shown to be stronger than conventionally mortared masonry). By applying the mortar/adhesive with a bag or pump actuated dispenser, as will be described further below, rather than a trowel, much quicker installation is achieved with the use of significantly less skilled labor and less mortar waste or “trash”

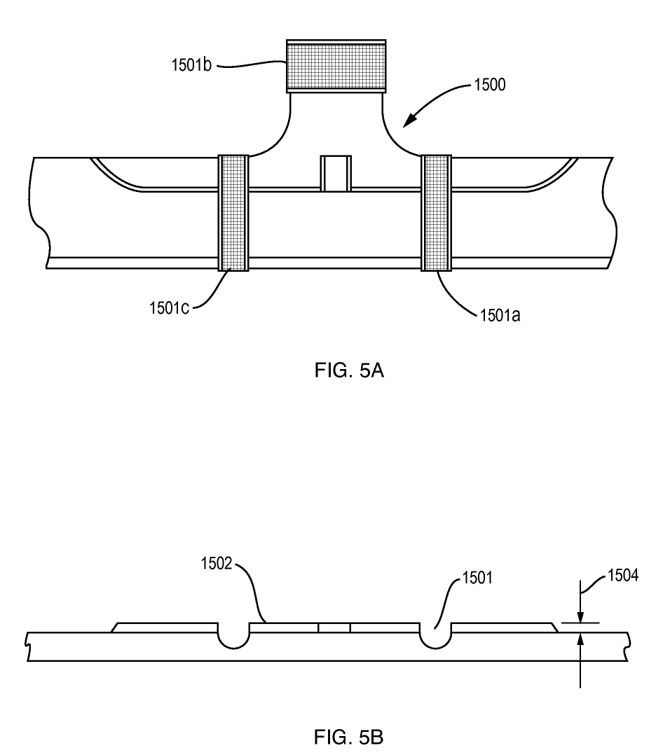

The blocks according to the present invention may include both a raised pad area 1500, FIGS. 5A and 5B that are provided to be ground for height adjustment as well as one or more receded areas 1501 of approximately 5/16 inch wide by ¼ in deep that may be provided on one side of the block to accommodate a brick tie back, such a Wirebond brand model 1800 tie back. Each block (also called a stretcher unit) is passed under a grinding wheel or wheels having sufficient width (from a few inches to approximately 7 inches) to grind the top surface 1502 of the raised pad 1500 to the desired height or thickness 1504 of in the range of 3/16 of an inch.

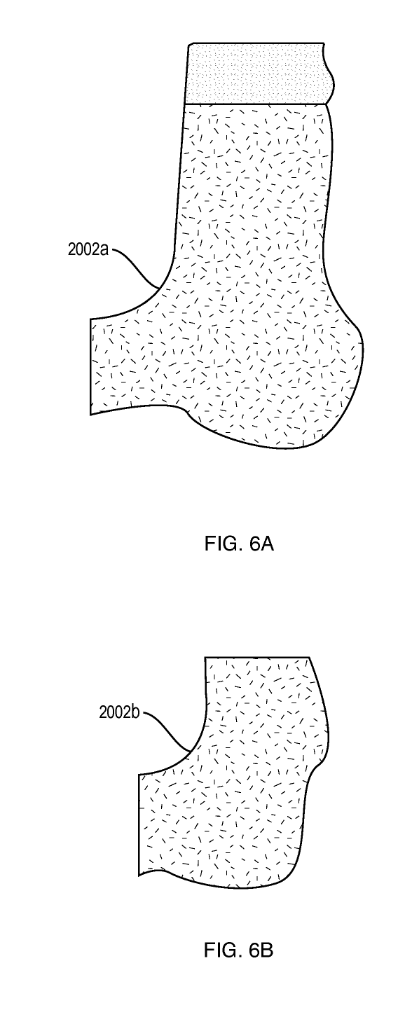

Cement blocks manufactured and erected into a wall, according to the teachings of the present invention, may not have mortar or adhesive between the vertical joints of adjacent blocks, as commonly done in the prior art and may or may not have any visible mortar between the adjacent blocks horizontally. Such mortar is not necessary structurally using the block and methods taught by the present invention. However, FIG. 6A illustrates a side corner region 2002a of a cement block according to another feature of the present invention, that has a profile which is ground or preferably manufactured into the block, and which provides a recessed horizontal groove or pocket between adjacent vertically displaced blocks of approximately 7/16 inch tall and ⅛ inch deep, and that allows a bead of mortar to be placed between adjacent blocks (blocks above and below) to achieve the traditional mortared block visual effect desired by many customers and to increase the waterproof characteristics of the finished erected cement block wall. A similar manufactured or ground corner region 2002b, FIG. 6B, may be provided which provides a recessed vertical groove or pocket between adjacent horizontally displaced blocks (blocks to the left and right) of approximately 3/16 inch high and ⅛ inch deep, and that allows a bead of mortar to be placed between the adjacent horizontally displaced blocks to also achieve the traditional mortared block visual effect desired by many customers and to increase the waterproof characteristics of the finished erected cement block wall.

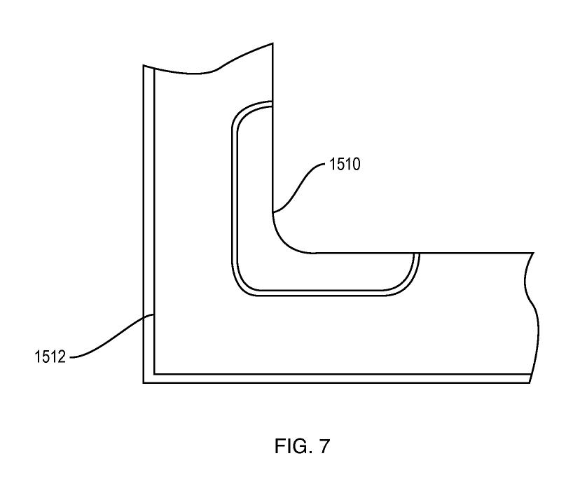

FIG. 7 illustrates a corner detail of a block showing an embodiment of a corner block with a raised pad area 1510 provided at or near the corner 1512 of a block. The corner pad 1510 is also precision ground to the desired height at the same time that pads 1500 (previously shown) in the central region of the block are ground.

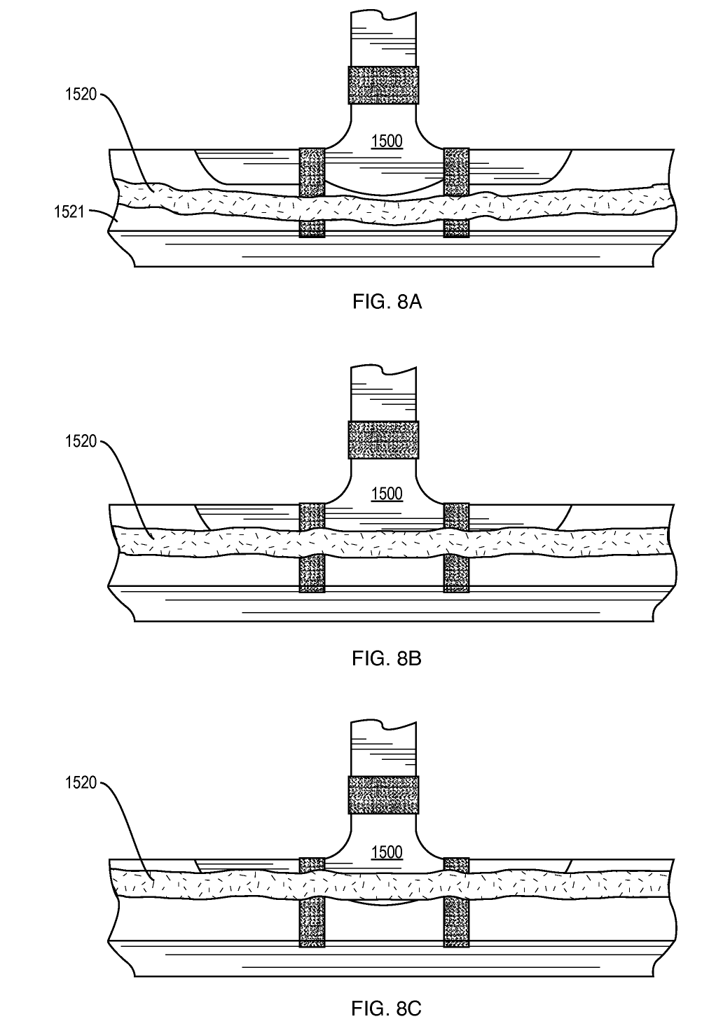

By controlling the location of where a bead/slug of adhesive/mortar 1520 FIG. 8A is applied on the top surface of a block constructed in accordance with the teachings of the present invention (closer to the front 1521 of the block NOT over the raised and ground pad 1502), the finished height of the block is dictated almost exclusively by the ground surfaces 1502 with the mortar/adhesive 1520 contributing little if any elevation to the block when the upper block is placed on top of it. However, applying a bead of the mortar/adhesive 1520 closer to the middle of the raised and ground pad 1500, FIG. 8B, means that the height of the block will be dictated to a slight degree by the mortar/adhesive, with the mortar/adhesive contributing approximately 1/64th of an inch of elevation to the block when the upper block is placed over it. Applying a bead of the mortar/adhesive 1520 closer to the back of and actually on the raised and ground pad 1500, FIG. 8C, means that the height of the block will be dictated to a greater degree by the mortar/adhesive, with the mortar/adhesive contributing approximately 1/32nd to 1/16 of an inch of elevation to the block when the upper block is placed over it.

Accordingly, the installer is able to quickly add fine height elevation control to the finished wall by simply changing the location of where a bead of mortar/adhesive is applied. This allows a user installing the blocks constructed according to the teachings of the present invention and using the methods disclosed herein, to handle any height elevation issues in the field and brought on by footer or base course issues, blocks being too wet or dry, too lightweight, normal or heavyweight, all without shims or other more costly and time consuming remedies.

The raised leveling pads of the present invention are designed to be run through a grinder to provide precision height control during assembly and construction of the finished wall. The pads are also designed to be wide or long enough, for example approximately 5.5 inches, to allow for blocks to be stacked directly one on top of another in a “stacked bonded” fashion without rocking. The pads may also be designed with channels to accommodate brick tieback anchors and to aid in the flow of the precision mortar to maintain precision height control when stacking using mortar (wet stacking).

The raised leveling pads of the present invention are also designed to be wide or long enough to allow for blocks to be stacked “offset” to one another in a “running bond” fashion without rocking.

In addition, as previously mentioned, the raised leveling pads of the present invention may also include one or more channels that facilitate the use of brick tiebacks. The channels may be full channels extending completely through the raised areas to accommodate the brick tie backs or other reinforcement wire, or partial channels extending halfway or quarter way through the raised area to provide relief areas for the precision, fine grain mortar to flow away from the top of the leveling pads to ensure that the block height during construction is maintained. Under normal circumstances, mortar is not normally applied to the top of the leveling pads but in front of them. However, in the event the height of the block needs to be increased during construction, the precision mortar may be applied either on top of or in close proximity to the leveling pads providing a “liquid shim” for the wall system.

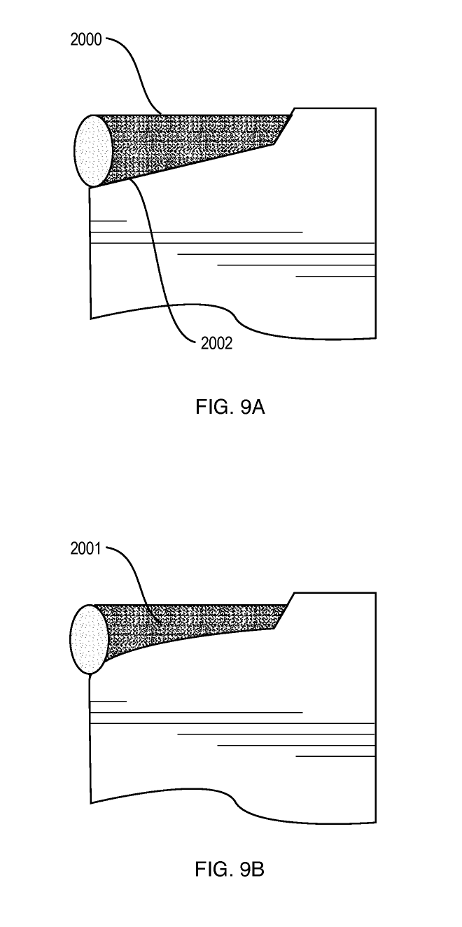

Another feature of the present invention is a block, in accordance with the teachings of one embodiment of the present invention, that includes at least one side region 2000, FIG. 9A, including a linear tapered or sloping bed and head joint area or alternatively having a surface 2001 FIG. 9B that is stepped or scalloped forming an arcuate region to reduce water penetration and to provide additional joint holding power. This provides a true traditional ⅜ inch joint at the face of the block that can be tooled in any way that conventional hand troweled walls are built. The sloped area 2000/2001 maybe machined, cast into the block or ground after the block is manufactured. In addition, a scalloped keyway 2002 FIG. 9A may be provided for additional water penetration resistance and mortar holding power. Examples of the application of mortar are shown and described below.

One additional feature of the present invention are novel tools that are designed (1) to fit onto a conventional grout bag and (2) onto a conventional mortar pumping system, to provide for an easy, fast, clean, and effective way to place the mortar/adhesive described above in which has not been available in the prior art.

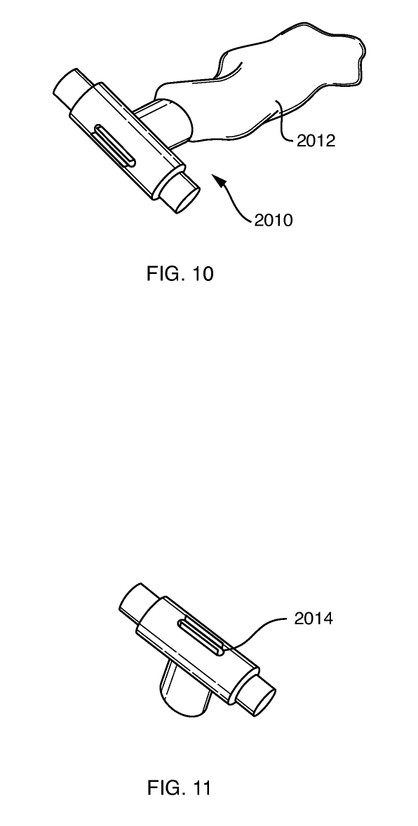

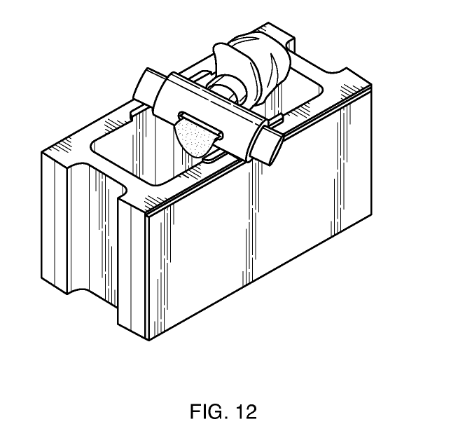

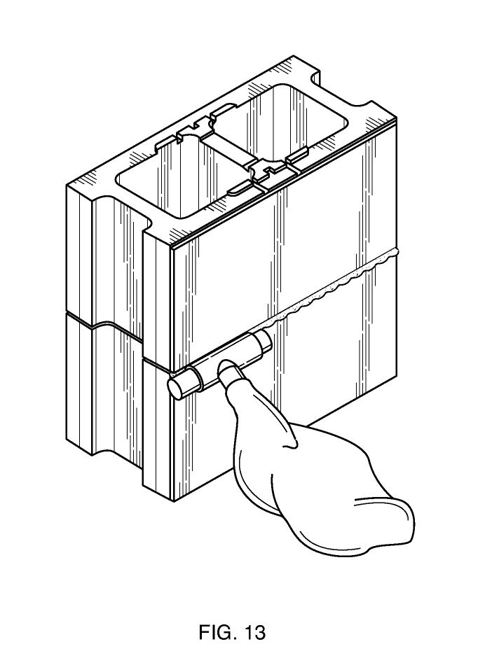

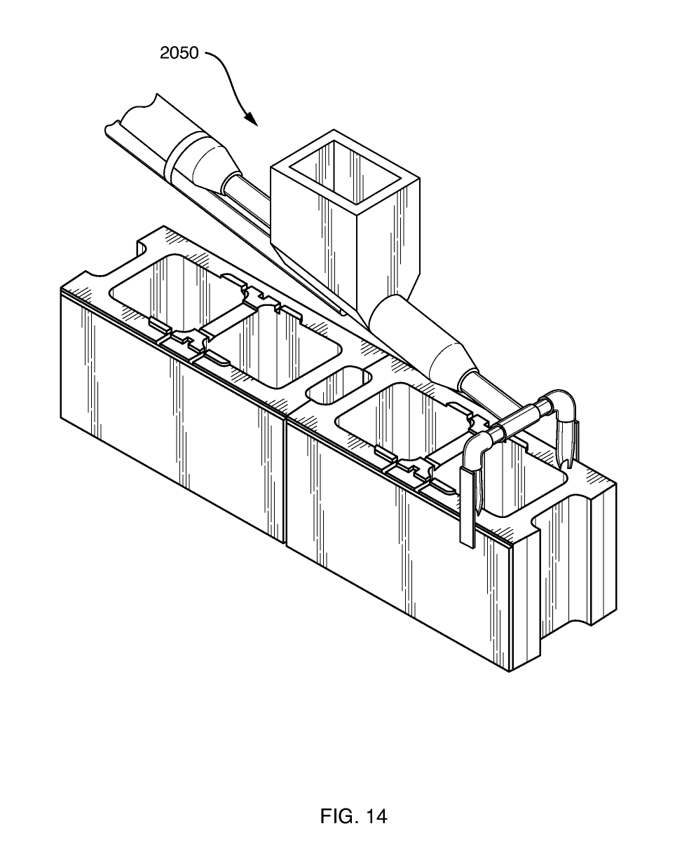

FIG. 10 shows the first tool 2010 in accordance with this aspect of the present invention that was developed for use with a standard grout bag 2010 containing mortar/adhesive that injects the mortar/adhesive into the joints of dry-stacked precision ground masonry blocks described herein and wherein the same tool also simultaneously “tools” the mortared joint at the same time. This Grout Bag Tool 2010 includes a slotted opening 2014, FIGS. 11 and 12, with an insert that controls the injection of the mortar/adhesive into the dry-stacked block and also tools the joint as the tool is moved across the head and bed joints FIG. 13. This grout bag coupled tool 2010 features a plastic specially designed T-Shaped coupling that is slotted at the bottom and is fitted with a plastic apron through the slot which allows the mortar/adhesive to flow into all the areas of the dry joints without oozing out past the face of the blocks and is thereby less messy and less clean-up or touch-up and therefore less labor. This tool does not require a skilled mason to utilize it.

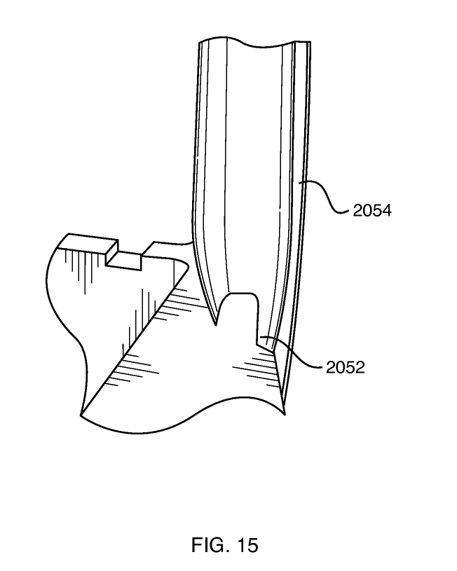

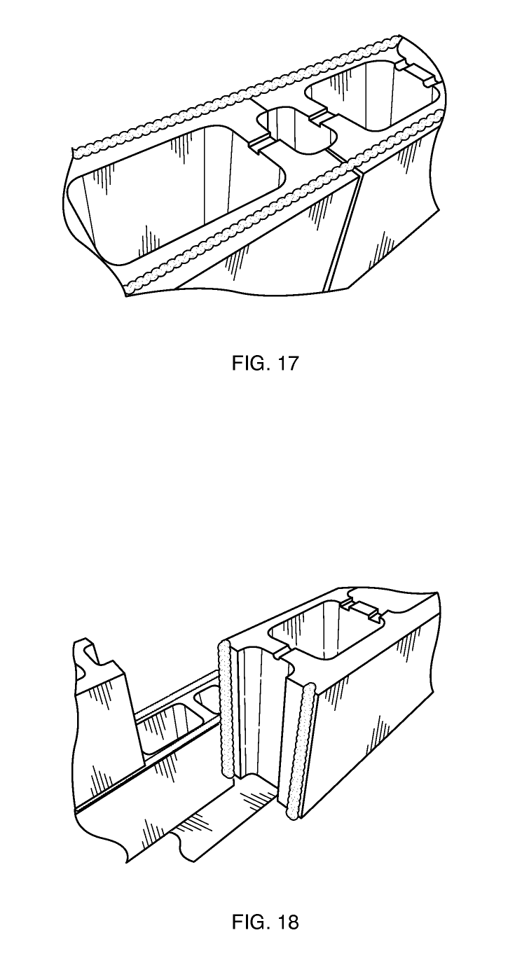

FIG. 14 illustrates a tool 2050 in accordance with another feature of the invention developed for use with a conventional high speed mortar pump (not shown) so that both sides (bed joints and head joints) of a block (either the precision ground block described herein or any standard or other building block) can be mortared with a bead of mortar/adhesive of the appropriate size/shape in a clean and effective manner. The mortar pump tool in accordance with the invention includes a special tapered and slotted tip 2052, FIG. 15, that allows the mortar to extrude a perfect continuous bead/slug of mortar/adhesive of appropriate height and width at the bed joints (FIG. 17) and head joints (FIG. 18) of concrete blocks at extremely high speeds by just squeezing the trigger to activate the grout pump and drag the assembly down the course of block to form a mortar bead of perfect alignment using the attached steel skirts 2954 for centering the tool on the joints.

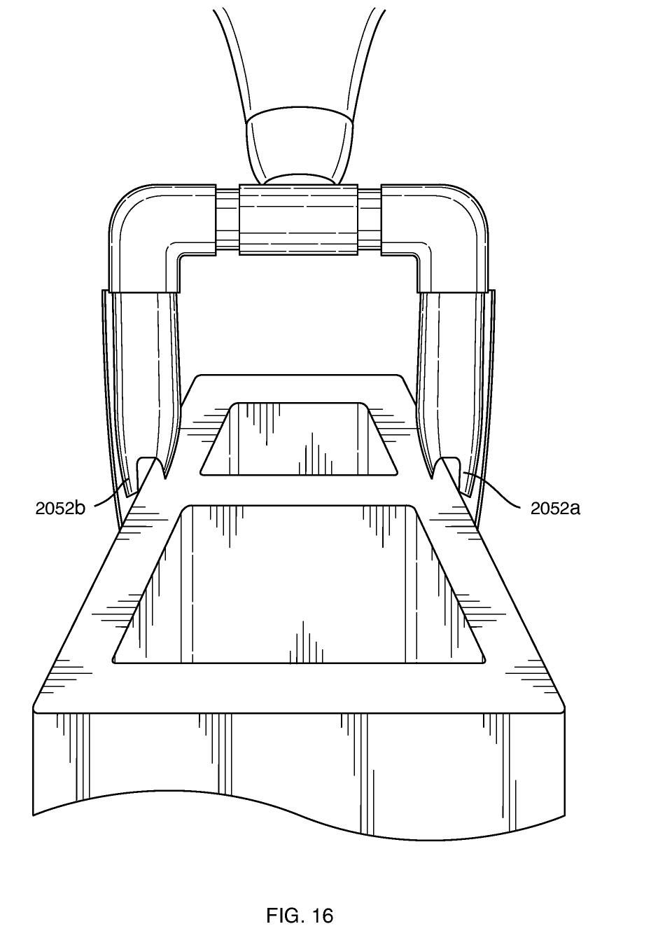

The mortar pump tool of the preferred embodiment of the present invention features twin tips 2052a and 2052b, FIG. 16 that are tapered in the appropriate direction to fit the geometry of the precision ground block described herein (although this is not a limitation of the present invention as any size block can be accommodated with the tool described herein and is considered within the scope of the present invention) and also slotted in such a way as to allow the mortar to flow down the tubing, then turn a right angle and through a special slot in each of the twin tips 2052 that has been sized to extrude a continuous mortar bead/slug of the right size and geometry to allow for a fast, clean and effective mortared/adhesive stacking of precision ground masonry blocks to form code approved masonry structures. Metal or other type of side skirts 2054 are fitted to the tubing tip 2052 so as to provide a well centered bead on the top of the face shells without need for any operator skill.

When tested, the mortar/adhesive disclosed and described herein was mixed and placed into both the grout bag and the mortar pump system. Both tools allowed for a quick and easy application of mortar, whether it was injected into the pre-stacked block with a grout bag or pumped onto the block to provide an ideal bead of mortar at both bed and head joints of the Block. The mortar/adhesive joints were installed without a trowel; easily, quickly, cleanly, and with excellent coverage (typically less than 1 lb. of mortar per block compared to the conventional 5 plus lbs. per block).

Accordingly, essentially anyone (unskilled labor) can construct masonry block walls with the described precision ground masonry block and the mortar/adhesive that is fast, easy and clean; all done effectively without a mason's trowel.

Modifications may be made to fit particular operating requirements and environments as will be apparent to those skilled in the art, the invention is not considered limited to the examples chosen for purposes of disclosure, and covers all changes and modifications which do not constitute departures from the true spirit and scope of this invention. Modifications and substitutions by one of ordinary skill in the art are considered to be within the scope of the present invention which is not to be limited except by the allowed claims and their legal equivalents.

The invention claimed is:

1. A method of producing a stackable building block for constructing a masonry wall, the method comprising the acts of:
molding a concrete block having a front section coupled to and substantially parallel with a rear section, each of the front and rear sections having a bottom surface and a top surface, wherein the top surface on both the front and rear sections includes at least a central region and/or a corner region having a height which is greater than the height of the block located on either side of the central or corner regions; and
grinding the raised central and/or corner regions of the top surface of the block to a predetermined height, said predetermined height having a close tolerance.

2. The method of producing a stackable building block for constructing a masonry wall of claim 1, wherein the central region has an undulating surface.

3. The method of producing a stacked building block wall utilizing the stackable building block of claim 1, further comprising the acts of:
applying a flowable, thin set mortar onto an area in front of, partially on top of or fully on top of the raised and ground areas on the top surface of the stackable building block using a high-speed applicator.

4. The method of producing a stacked building block wall utilizing the stackable building block of claim 3, wherein the high-speed applicator is one of a grout bag or a mortar pump tool fitted with one or more mortar/adhesive applicator extrusion tips, for simultaneously applying one or more continuous, generally uniform, beads/slugs of mortar/adhesive.

5. The method of producing a stacked building block for constructing a masonry wall of claim 3, wherein the mortar is applied to a thickness of typically ⅛ of an inch or less.

6. The method of producing a stackable building block for constructing a masonry wall of claim 1, wherein the grinding of the higher surface of the top surface to a close tolerance is precision ground to provide a stack building block of a specific precision height with a close tolerance of +/− 1/64″.

7. The method of producing a stackable building block for constructing a masonry wall of claim 1, wherein the central region of the top surface further includes a plurality of indents or serrations or channels.

8. The method of producing a stacked building block wall utilizing the stackable building block of claim 7, and further comprising the acts of:
applying a flowable, thin set mortar onto the top surface of the stackable building block using a high speed applicator; and
allowing the mortar to enter the plurality of indents or serrations or channels on the central region of the top surface, wherein the addition of the mortar does not significantly increase the specific precision height of the stackable building block.

9. The method of producing a stack building block for constructing a masonry wall of claim 1, wherein the stack building block has a chamfered or beveled edge on one more exterior edges of the building block.

10. The method of claim 1, wherein the block includes at least one of a bed joint region or head joint region which is downwardly tapered from an area beginning inward of the edge of the block up to the edge of the block.

11. The method of claim 10, wherein said downwardly tapered bed joint region or head joint region further includes an indented keyway configured for providing water penetration resistance and mortar holding power.

12. The method of claim 10, wherein said downwardly tapered bed joint region or head joint region includes a stepped or scalloped, generally not smooth configuration.

13. A stackable building block for constructing a masonry wall, comprising:
a concrete block having a front section coupled to and substantially parallel with a rear section, each of the front and rear sections having a bottom surface and a top surface, wherein the top surface on both the front and rear sections includes at least a central region and/or a corner region having a height which is greater than the height of the block located on either side of the central or corner regions, and wherein the raised central and/or corner regions of the top surface of the block are ground to a predetermined height; and
wherein the block includes at least one of a horizontal top (bed) joint and a vertical side (head) joint region which is downwardly tapered from an area beginning inward of an edge of the block up to the edge of the block.

14. A method of constructing a masonry wall, the method comprising the acts of:
providing a concrete block having a front section coupled to and substantially parallel with a rear section, each of the front and rear sections having a bottom surface and a top surface, wherein the top surface on both the front and rear sections includes at least a central region and/or a corner region having a height which is greater than the height of the remainder of the top surface of the block located on either side of the central or corner regions, and wherein the raised central and/or corner regions of the top surface of the block are ground to a predetermined height, and; wherein the block includes at least one of a horizontal top (bed) joint and a vertical side (head) joint region which is downwardly tapered from an area beginning inward of an edge of the block up to the edge of the block;
applying a flowable, thin set mortar onto one or more ends of one or more stackable building block using a high speed applicator;
arranging a plurality of blocks having said applied flowable, thin set mortar applied onto said one or more ends into a desired configuration having a single row;
applying a flowable, thin set mortar onto said top surface of said plurality of arranged stackable building blocks using said high speed applicator; and
repeating the steps of applying a flowable, thin set mortar onto one or more ends of one or more stackable building block using a high speed applicator, arranging a plurality of blocks having said applied flowable, thin set mortar applied onto said one or more ends into a desired configuration having a single row and applying a flowable, thin set mortar onto said top surface of said plurality of arranged stackable building blocks using said high speed applicator until the concrete block wall is of a desired height.

15. The method of claim 14 wherein said high speed applicator includes one or more extrusion applicator tips, for simultaneously applying one or more continuous, uniform beads/slugs of flowable, thin set mortar onto said top surface and/or end region of said stackable building blocks.
